(19) United States
(12) Patent Application Publication
(10) Pub. No.: US 2006/0232191 A1
(43) Pub. Date: Oct. 19, 2006

(54) Gate-controlled electron-emitter array panel, active matrix display including the same, and method of manufacturing the panel

(75) Inventor: Jeong-Hwan Yang, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/377,463

(22) Filed: Mar. 16, 2006

Related U.S. Application Data
(60) Provisional application No. 60/671,628, filed on Apr. 15, 2005.

(51) Int. Cl. H01J 1/62

(52) U.S. Cl. 313/497

(57) ABSTRACT

An active matrix display comprising an array of gate-controlled surface-conduction electron-emitter devices (GC_SEDs). Each gate-controlled_surface-conduction electron-emitter device (GC_SED) comprises a first electrode, and a pair of (second and third) electrodes that are insulated from the first electrode and that are spaced apart from each other to bound an electron-emitting area overlapping the first electrode. The potential barrier in the electron-emitting area (slit) between the second and third electrodes is modulated (controlled, switched) by applying a voltage to the first electrode that serves as a gate that effectively controls the tunneling of the electrons, between the second and third electrodes. Efficient electron tunneling is allowed through modulation of potential barrier by the first electrode functioning as a gate even though the distance (width of the electron-emitting area, slit) between the second and third electrodes may be significantly more than 10 nanometers.

### CROSS-REFERENCE TO RELATED PATENT APPLICATION

This application claims the priority under 35 U.S.C. § 120 of U.S. provisional Patent Application No. 60/671,628, filed on Apr. 15, 2005, the contents of which is incorporated by reference herein in its entirety.

### BACKGROUND OF THE INVENTION

1. Field of the Invention

The present invention relates to a flat panel display, and more particularly, to a gate-controlled electron-emitter array panel, a display including the same, and a method of manufacturing the panel.

2. Description of the Related Art

With the advent of high definition TVs and broadband networks, there is increasing demand for a large-screen flat panel displays with high resolution and image quality.

SED stands for Surface-conduction Electron-emitter Display. It is a revolutionary flat-panel design, which combines the best aspects of LCD (easy-to-manage size and weight, and low power consumption), with the picture quality advantages of a top-notch tube (CRT) TV (excellent response time, natural color, and deep, rich blacks). A flat-panel display technology, SED uses phosphors activated by an electron emitter, just like standard cathode-ray tube (CRT) tube televisions. Like conventional CRTs, SEDs utilize the collision of electrons with a phosphor-coated screen to emit light. Electron emitters, which correspond to an electron gun in a CRT, are distributed in an amount equal to (or greater than) the number of (R, G, B color) pixels on the display.

The surface-conduction electron-emitter consists of a thin slit (between two electrodes) across which electrons tunnel when excited by moderate voltages (e.g., tens of volts). When the electrons cross the thin slit, some are scattered at the receiving pole and are accelerated toward the display surface by a large voltage gradient (e.g., tens of kV) between the display panel and the surface conduction electron emitter apparatus. Electrons are ejected when a voltage of about 16 to 18 V is applied to the electrodes between the emitter (slit). Since tunneling is a discrete process, the electric charge that flows through the tunneling flows in multiples of e, the charge of a single electron. The emitted electrons are then accelerated by the higher voltage into an electron beam similar to that in a CRT display.

A surface-conduction electron-emitter display (SED), being self-emissive like a cathode-ray tube (CRT), is rather a slim flat panel display that provides high efficiency, high brightness and wide brightness range, natural color and high color purity, and wide viewing angle. Since SEDs produce light only from the “ON” pixels, power consumption is dependent on the display content. This is an improvement over LCDs, where all light is created by a backlight which is always ON, regardless of the actual image on the screen. The LCD's backlight itself is a problem (power drain). However, the SED doesn't have the problem. SEDs do not have the limitation of displaying only pixels of one color at a time (field sequential color) and can display pixels of all colors at the same time.

The surface-conduction electron-emitter display (SED) is expected to gain wide acceptance for use in television receivers. Some SEDs have a diagonal measurement exceeding one meter (approximately 40 inches), yet they consume only about 50 percent of the power of cathode-ray tube (CRT) displays, and 33 percent of the power of plasma displays having a comparable diagonal measurement.

Having a quick response time of 1 millisecond, a SED can be employed as monitors for personal computers and laptops. A SED display can keep up with sports, games, and other fast-action video, creating a smoother, more natural look. When strings of alphabet letters scroll quickly across SED screens, individual letters remain clear and distinct on the SED, while some blurring is typically visible on both the plasma and LCD displays. SED technology can be used beneficially in screens ranging from 2 inches to 100 inches. The SED requires no electron-beam focusing, and operates at a much lower voltage than a CRT. The brightness and contrast compare favorably with high-end CRTs.

FIG. 1 is a cross-sectional view of an electron-emitter portion of a conventional SED. The SED consists of an array of surface-conduction electron emitters (26, 27, 28) and a layer of phosphors (14), separated by a vacuum (space from which all the air has been evacuated). Each electron emitter—phosphor pairing represents one color (e.g., G, Green) pixel.

Referring to FIG. 1, each electron-emitter in a conventional SED includes a pair of electrodes 26 and 28 that are spaced apart from each other to define an electron-emitting area 27 (within an extremely narrow slit, e.g., less than 10 nm). The pair of electrodes 26 and 28 allow electrons to tunnel into the electron-emitting area 27 in a vacuum state.

Referring to FIG. 1, a conventional SED further includes a first panel and a second panel vacuum sealed together. The first panel is a phosphor array panel including a transparent (e.g., glass) substrate 12, a phosphor layer 14 formed on the transparent substrate 12, and a metal back 16 formed on the phosphor layer 14. The phosphor layer 14 is formed by depositing colored (e.g., red, green, and blue) phosphors (in a stripe or delta shape) in a matrix (array) arrangement. A black matrix 15 is sandwiched disposed between and around each of the (red, green, and blue) color phosphors and prevents shift of display colors due to a variation in electron beam irradiation position, degradation of contrast, and charging-up of phosphors due to an electron beam. The black matrix 15 may contain graphite as its main component.

The metal back 16 improves the efficiency of light utilization by reflecting some of light emitted by the phosphor layer 14, protects the phosphor layer against collision with electrons, serves as an electrode applying an electron beam accelerating voltage, and is used as a conductive path for electrons that have excited the phosphor layer 14.

A transparent electrode (not shown) made of a material such as indium tin oxide (ITO) may be disposed between the transparent substrate 12 and the phosphor layer 14 when necessary.

The surface-conduction electron emitter consists of two electrodes (26 & 28) and an ultrafine particle layer overlapping the electrodes. The ultrafine particle layer has a plurality of nanometer-scale slits therein. In conventional SEDs, the key to the electron emitters, at the heart of the SED, is assumed to be an extremely narrow slit (e.g., only several nanometers wide) between two electrodes (26 and 28). Electrons are emitted from one side of the narrow slit when approximately 10V of electricity is applied. Some of these electrons are scattered at the other side of the slit and then accelerated by the voltage (approximately 10 kV) applied (through the vacuum) between the substrates, causing light to be emitted when they collide with the phosphor-coated glass plate.

Because it is difficult to fabricate a plurality of uniform nanometer scale slits (e.g., slits only several nanometers apart), uniform electron emission characteristics are difficult to achieve across the entire surface of the display. Electron emitters have been developed with widths of a few nanometers (billionths of a meter). This leads some engineers to believe that SED technology can offer unprecedented image resolution. However, when the surface-conduction electron emitters are arranged in a matrix array, only passive matrix driving is supported, disabling the conventional SED display from being effectively addressed.

### SUMMARY OF THE INVENTION

According to an aspect of the present invention, there is provided a display including gate-controlled electron-emitter array panel comprised of a plurality of gate-controlled surface-emission electron-emitter devices (GC_SEDs). Each GC_SED comprises a first electrode, and a pair of second and third electrodes that are insulated from the first electrode and that are spaced apart from each other to bound an electron-emitting area (slit) overlapping the first electrode. The potential barrier in the electron-emitting area (slit) between the second and third electrodes is modulated (controlled, switched) by applying a (bias, gate) voltage to the first electrode that serves as a gate that effectively controls the tunneling of the electrons, between the second and third electrodes. Efficient electron tunneling is allowed through modulation of potential barrier by the first electrode functioning as a gate even though the distance (width of the electron-emitting area, slit) between the second and third electrodes may be significantly more than 10 nanometers. The gate electrodes of the GC_SEDs are individually addressable, and that allows for active matrix driving of the display.

According to another aspect of the present invention, there is provided a gate-controlled electron-emitter display comprising a phosphor array panel, and a second panel, including an array of GC_SEDs, that faces the phosphor array panel. Each GC_SED comprises a first electrode and a pair of second and third electrodes that are insulated from the first electrode and that are spaced apart from each other to bound an electron-emitting area (slit) overlapping the first electrode.

According to still another aspect of the present invention, there is provided a method of manufacturing a gate-controlled electron-emitter array panel comprising forming a first electrode on a substrate, forming an insulating layer on the first electrode, and forming on the insulating layer a pair of second and third electrodes that are insulated from the first electrode and that spaced apart from each other to bound an electron-emitting area (slit) therebetween so that the electron-emitting area overlaps the first electrode.

Other features of the present invention may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Thus, in some embodiments, well known methods, procedures, components, and circuits have not been described in detail so as not to unnecessarily obscure aspects of the present invention. Like reference numerals throughout the figures and specification denote like elements.

It is noted that the use of any and all examples, or exemplary terms provided herein is intended merely to better illuminate the invention and is not a limitation on the scope of the invention unless otherwise specified. The use of the singular terms in the context of describing the invention are also to be construed to cover the plural, unless otherwise indicated herein or clearly contradicted by context. The terms “comprising,” “having,” “including,” and “containing” are to be construed as open-ended terms (i.e., meaning “including, but not limited to,”) unless otherwise noted. The wording “and/or” includes each individual item listed and any combination of items.

The present invention will be described with reference to perspective views, cross-sectional views, and/or plan views, in which preferred embodiments of the invention are shown. Thus, the profile of an exemplary view may be modified according to manufacturing techniques and/or allowances. The embodiments of the invention are not intended to limit the scope of the present invention but cover all changes and modifications that can be caused due to a change in manufacturing process. For example, while an etched region is shown in a rectangular shape, it may be rounded or have a predetermined curvature. Thus, regions shown in the drawings are illustrated in schematic form and the shapes of the regions are presented simply by way of illustration and not as a limitation.

### BRIEF DESCRIPTION OF THE DRAWINGS

The above and other features of the present invention will become more apparent to persons skilled in the art by describing in detail preferred embodiments thereof with reference to the attached drawings, in which:

FIG. 1 is a cross-sectional view of a surface-conduction electron-emitter portion of a conventional Surface-conduction Electron-emitter Display (SED);

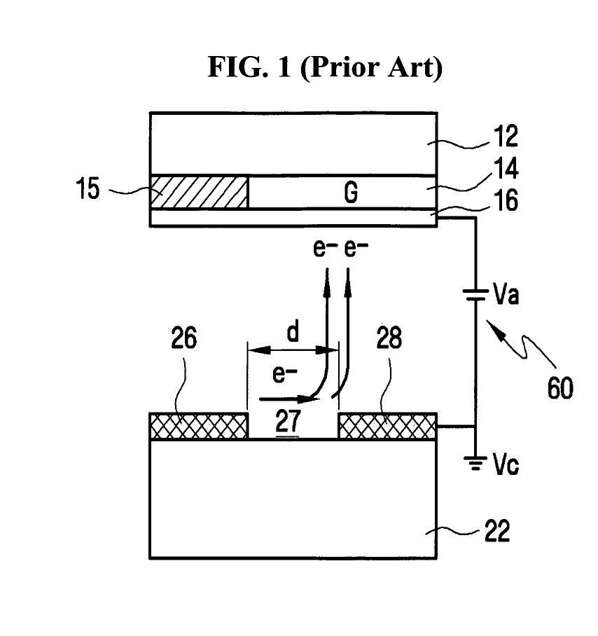

FIG. 2A is an exploded perspective view of a gate-controlled electron-emitter display according to an embodiment of the present invention;

FIGS. 2B & 2C are cross-sectional views of a portion of the gate-controlled electron-emitter display of FIG. 2A;

FIG. 2B is a cross-sectional view showing one gate-controlled surface-emission electron-emitter device (GC_SED) in the display of FIG. 2A;

FIGS. 3A and 3B are plan views showing array portions of the gate-controlled electron-emitter display of FIG. 2A;

FIG. 4 is a block diagram of a driving circuit of the display of FIG. 2A;

FIG. 5 is a combined voltage potential diagram and cross sectional diagram for explaining the operation of the display of FIG. 2A;

FIG. 6 is a graph illustrating the relationship between a gate-to-emitter (bias) voltage V (V=Vg−Ve) versus a distance between a GC_SED's emitter (source) and collector (drain);

FIGS. 7A-7C are cross-sectional views illustrating a first process of fabricating the array of a gate-controlled electron-emitter display shown in FIG. 2A;

FIGS. 8A-8C are cross-sectional views illustrating a second process of fabricating the gate-controlled electron-emitter array display shown in FIG. 2A; and

FIG. 9 is a block diagram of an image processing system employing the display 200 of FIG. 2A.

### DETAILED DESCRIPTION OF EXEMPLARY EMBODIMENTS OF THE INVENTION

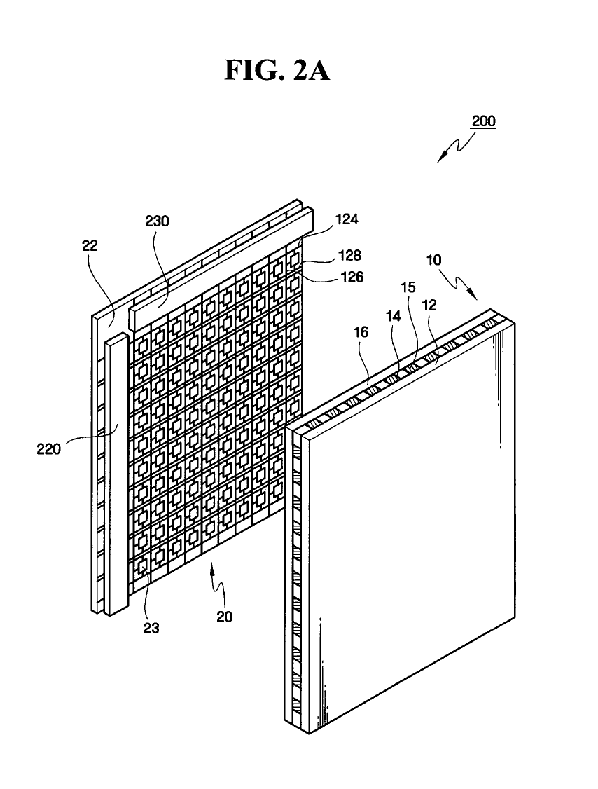

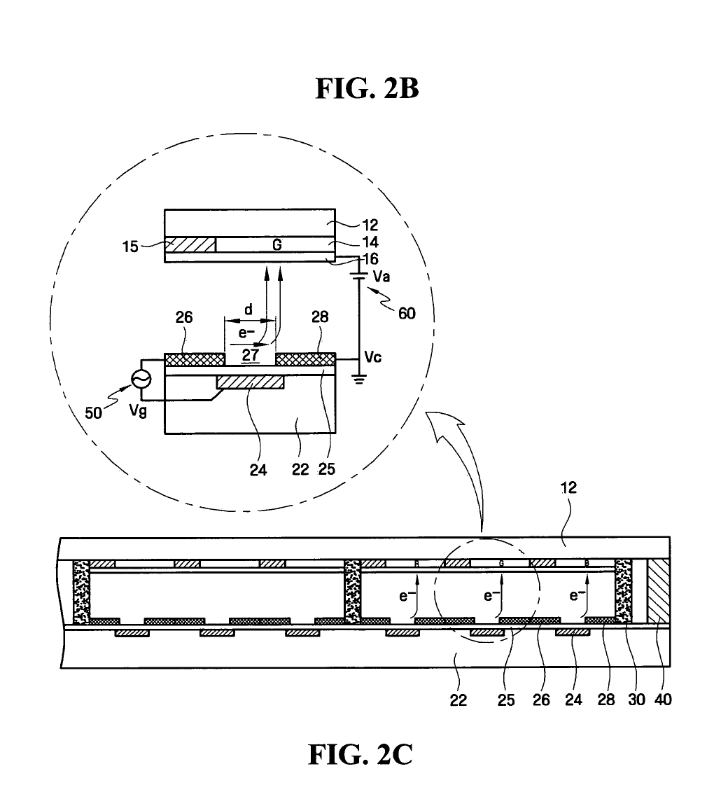

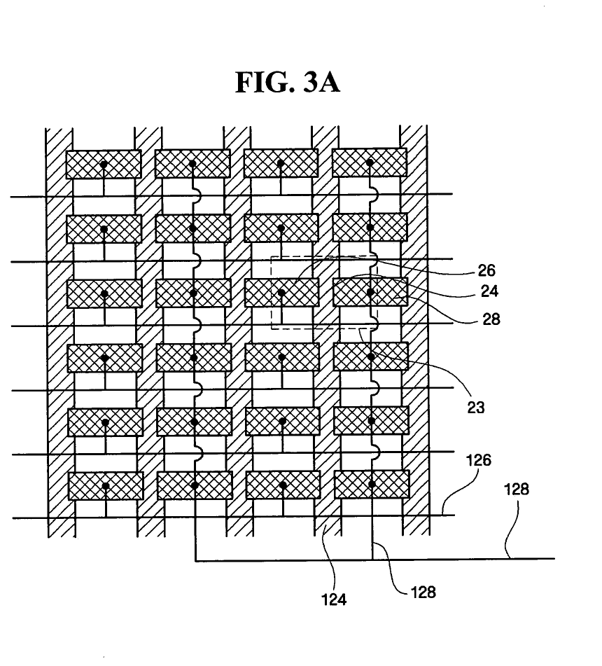

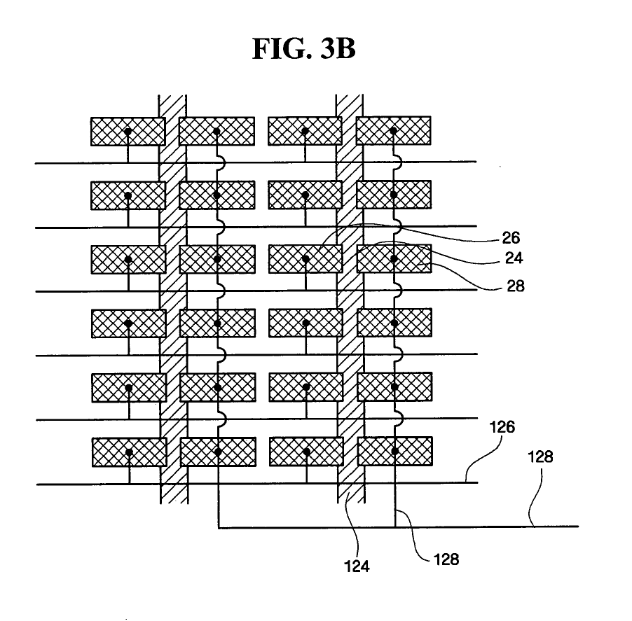

FIG. 2A is an exploded perspective view of a gate-controlled electron-emitter display according to an embodiment of the present invention; FIGS. 2B & 2C are cross-sectional views of a portion of the gate-controlled electron-emitter display of FIG. 2A. FIGS. 3A and 3B are plan views showing array portions of the gate-controlled electron-emitter display of FIG. 2A.

Referring to FIGS. 2A, 2B, 2C, 3A and 3B, a gate-controlled electron-emitter display 200 according to an embodiment of the present invention includes a first panel 10 and a second panel 20 vacuum sealed together.

The first panel 10 is a phosphor array panel including a transparent substrate 12, a phosphor layer 14 formed on the transparent substrate 12, and a metal back 16 formed on the phosphor layer 14.

The phosphor layer 14 is formed by depositing red, green, and blue phosphors (in a stripe or delta shape) in a matrix (array) arrangement. A black matrix 15 is disposed between and around each of the (red, green, and blue) color phosphors and prevents shift of display colors due to a variation in electron beam irradiation position, degradation of contrast, and charging-up of phosphors due to an electron beam. The black matrix 15 may contain graphite as its main component, but it is not limited thereto.

The metal back 16 improves the efficiency of light utilization by reflecting some of light emitted by the phosphor layer 14, protects the phosphor layer against collision with electrons, serves as an electrode applying an electron beam accelerating voltage, and is used as a conductive path for electrons that have excited the phosphor layer 14.

A transparent electrode (not shown) made of a material such as indium tin oxide (ITO) may be disposed between the transparent substrate 12 and the phosphor layer 14 when necessary.

The second panel 20 is a gate-controlled electron-emitter array panel including a plurality of gate-controlled_surface-conduction electron-emitter devices (GC_SEDs) 23. A GC_SED is included in each pixel and they are arranged on a substrate 22 in a matrix (array) corresponding to the array of color (red, green, and blue) phosphors. First, second and third conductive lines 124, 126, and 128 are provided to each pixel arranged in the matrix and are respectively connected to three electrodes of the GC-SED 23 of each pixel on the substrate 22, thereby allowing active matrix driving.

An X-axis driving IC 220 and a Y-axis driving IC 230 are mounted on (a peripheral area of) the substrate 22 (e.g., using Chip On Film (COF) or Tape Carrier Package (TCP) that will be attached onto a flexible printed circuit board by means of Tape Automated Bonding (TAB)). Alternatively, the X- and Y-axis driving ICs 220 and 230 may be directly mounted face-down on the substrate 22 (e.g., using Chip On Glass (COG)) or integrated into the substrate 22 along with the GC_SEDs 23.

Referring to FIG. 2, the first panel 10 faces the second panel 20 that is spaced apart a predetermined distance from the first panel 10 using a column spacer 30. Because a vacuum should be maintained between the first and second panels 10 and 20 (to induce electron acceleration within the display 200), peripheral portions of the first and second panels 10 and 20 are sealed together with a sealing element 40. Although not shown in FIG. 2A, an air exhaustion hole may be formed in a portion of the second panel 20 to create the vacuum between the first and second panels 10 and 20.

Referring to FIGS. 2A, 2B, and 2C, each GC_SED 23 includes a first electrode 24 and a pair of second and third electrodes 26 and 28 that are insulated from the first electrode 24 and spaced apart from each other to define an electron-emitting area 27 overlapping the first electrode 24. The pair of second and third electrodes 26 and 28 respectively act as the transistor's “emitter” and “collector” (or “source” and “drain”) and allow electrons to tunnel into the electron-emitting area 27 in a vacuum state. The first electrode 24 serves as a gate that effectively controls the tunneling of the electrons, between the transistor's emitter (source) 26 and collector (drain) 28, by modulating a potential barrier in the electron-emitting area (slit) 27.

Referring to FIG. 2A, in order to avoid interruption of the path of electrons emitted from the electron-emitting area (slit) 27, the first electrode 24 is farther away from the first panel 10 than the second and third electrodes 26 and 28. Efficient electron tunneling is allowed through modulation of potential barrier by the first electrode 24 functioning as a gate even though the distance d (of the electron-emitting area (slit) 27) between the second and third electrodes 26 and 28 is significantly large (e.g., more than several nanometers and less than 1 μm).

Thus, while a conventional SED (FIG. 2A) has an ultrafine particle layer with a slit width (d) limited to less than a few nanometers, the GC_SED 23 of the present invention may have an increased slit width (distance d) of from 10 nm to 1 μm (by adjusting the magnitude of a voltage being applied to the first electrode 24). Of course, the GC_SED 23 may have the (slit width) distance d of a few nanometers, e.g., about 1 nm as in the conventional SED.

The first electrode 24 is separated from the second and third electrodes 26 and 28 by a distance sufficiently large to enable modulation of the potential barrier (in the electron-emitting area (slit) 27). The thickness of an insulating layer 25 should be in the range of from 10 nm (or less) up to 1 μm to enable proper modulation of a potential barrier.

As shown in an enlarged cross-sectional view A of a pixel of FIG. 2A, a switchable (e.g., a stepped, discrete “alternating current” (AC)) bias) voltage (gate voltage Vg) 50 is applied to the first electrode 24 functioning as a gate (of the GC_SED 23) in a pixel and the second electrode 26 functioning as an transistor's (GC_SED 23) “emitter” (or a transistor's “source”). Thus, a combination of voltages is used to facilitate efficient addressing for each pixel. A ground voltage or a predetermined (common) voltage may be applied to the third electrode 28 to create a potential difference from the voltage (emitter voltage) Ve applied to the second electrode 26 and thus to allow electron emission from the 27 electron-emitting area (slit). Thus, the third conductive lines 128 may be commonly connected across the entire second panel 20.

An accelerating voltage Va 60 is applied to the metal back 16 of the first panel 10 to accelerate emitted electrons toward the phosphor layer 14.

Referring to FIGS. 3A and 3B, the first through third conductive lines 124, 126, and 128 arranged in a matrix form are respectively connected to the three electrodes 24, 26, and 28 in the GC_SED 23 to enable (active) matrix driving.

More specifically, the first conductive lines 124 connected to the first electrodes 24 and the third conductive lines 128 connected to the third electrodes 28 are arranged perpendicular to the second conductive lines 126 connected to the second electrodes 26, thereby allowing active matrix driving.

FIG. 3A shows a case in which each of the second and third electrodes 26 and 28 are shared by two adjacent pixels to achieve high integration and FIG. 3B shows a case in which they are arranged to define a single pixel, when increasing an integration density is not a critical challenge.

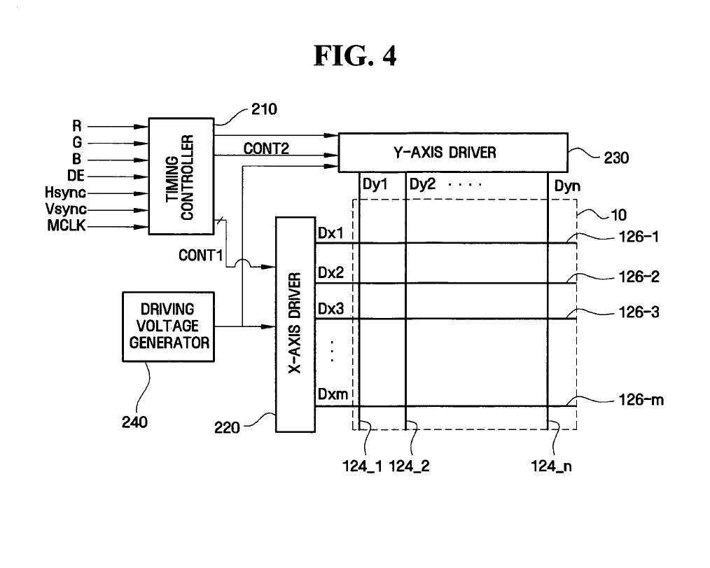

FIG. 4 is a block diagram of a driving circuit of the display of FIG. 2A.

Referring to FIG. 4, the driving circuit includes a timing controller 210, an X-axis driver 220, a Y-axis driver 230, and a driving voltage generator 240.

The timing controller 210 receives red, green, and blue image signals R, G, and B and input control signals (for controlling the display of the image signals R, G, and B), such as vertical synchronization signal Vsync, horizontal synchronization signal Hsync, main clock MCLK, and data enable signal DE, from an external graphic controller (not shown). The timing controller 210 processes the image signals R, G, and B suitably for operation conditions of the display 200 and generates first and second control signals CONT1 and CONT2 based on the input control signals, and supplies the first control signal CONT1 to the X-axis driver 220, and supplies the second control signal CONT2 and processed image signals R′, G′, and B′ to the Y-axis driver 230.

The X-axis driver 220 applies an ON-mode bias to a row of the display 200 selected according to the first control signal CONT1 while applying an off-mode bias to an unselected row. The conductive lines Dx1 through Dxm correspond to the conductive lines 126 (e.g., 126-1 through 126-m) in the array.

The Y-axis driver 230 sequentially receives the image data R′, G′, and B′ corresponding to a pixel in a row selected according to the second control signal CONT2, selects gray scale voltages corresponding to the respective image data R′, G′, and B′, and converts the image data R′, G′, and B′ to corresponding data voltages.

While ON-mode bias is being applied to the GC_SEDs 23 in a row (“1 horizontal period”), the Y-axis driver 230 supplies data voltages to corresponding conductive lines Dy1 (124-1) through Dyn (124-n). Thus, during a time period corresponding to the magnitude and width of a data voltage being applied to the GC_SEDs 23 in the selected row, electrons emitted to the electron-emitting area 27 (see FIG. 2) are accelerated (by an accelerating voltage applied to the metal back 16) and collide with the phosphor layer 14. With the collision, electrons of specific pixels within the phosphor layer 14 are excited and then electrons drop back their original energy level thereby emitting visible light to form an image to be displayed.

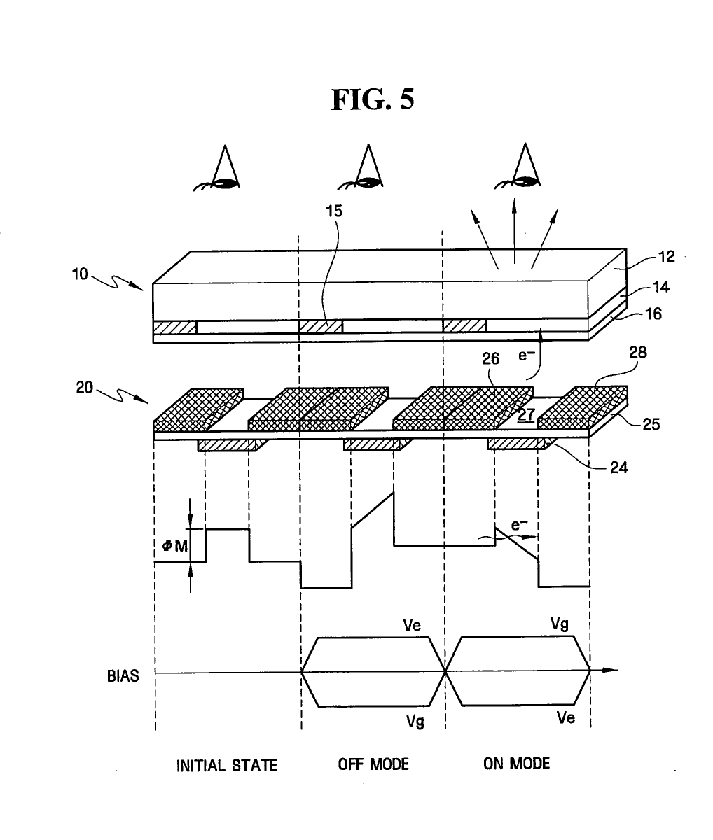

The light emission mechanism of the display 200 of FIG. 2A will now be described in detail with reference to FIG. 5.

FIG. 5 is a combined schematic voltage potential diagram and cross sectional diagram for explaining the operation of the display of FIG. 12A.

Referring to FIG. 5, initially, a potential barrier in the electron-emitting area 27 is determined by work functions øM of the second and third electrodes 26 and 28.

When a “positive” voltage and a lower (e.g., “negative”, ground) voltage are respectively applied to the second and third electrodes 26 and 28, the potential barrier (encountered by electrons that are present on a (distal) edge (the side edge of the electrode adjacent to the electron-emitting area 27) of the second electrode 26 in close proximity to the electron-emitting area 27 in a vacuum state) increases.

When a negative voltage is applied to the first electrode 24, the potential barrier may further increase, thus preventing substantial tunneling of electrons. Thus, upon applying negative and positive voltages to the first and second electrodes 24 and 26, respectively, the display 200 is put into OFF-mode.

Conversely, when a negative voltage and a ground voltage are respectively applied to the second and third electrodes 26 and 28, potential barrier (encountered by electrons that are present on the (distal) edge of the second electrode 26 in close proximity to the electron-emitting area 27 in a vacuum state) decreases. In this case, when a positive voltage is applied to the first electrode 24, the potential barrier further decreases, thus allowing substantial electron tunneling. Thus, upon applying a positive voltage and a negative voltage to the first and second electrodes 24 and 26, respectively, the display 200 is put into ON-mode.

Electrons emitted from the electron-emitting area 25 are accelerated by accelerating voltage applied to the metal back 16 and strike the phosphor layer 14. With the collision, electrons of specific elements within the phosphor layer 14 are excited and then electrons drop back their original energy level thereby emitting visible light to form an image to be displayed.

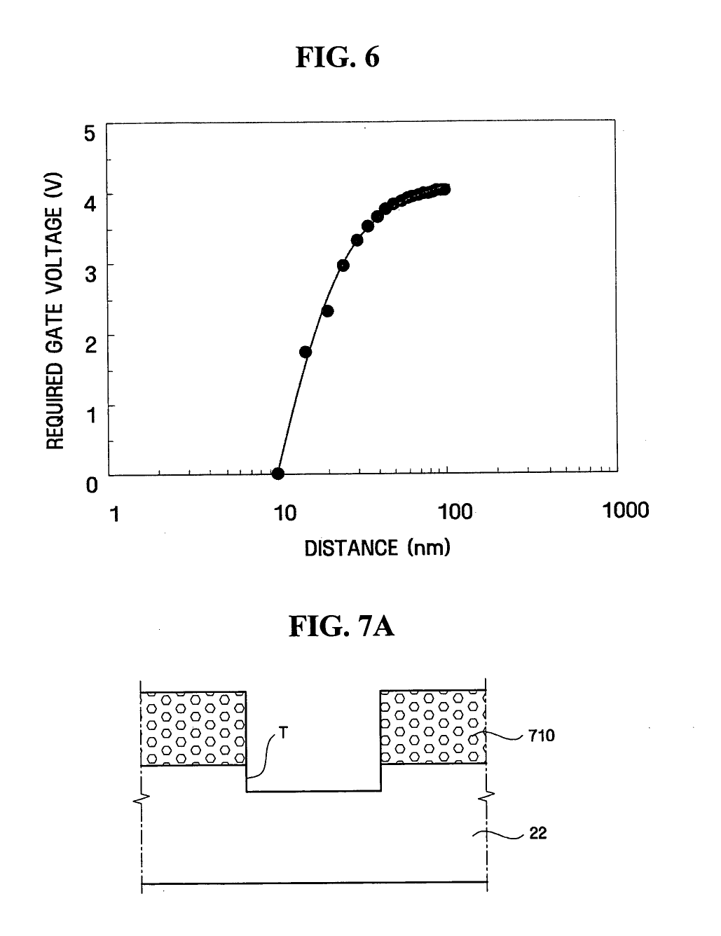

FIG. 6 is a graph illustrating the relationship between a gate voltage Vg of the first electrode 24 of the GC_SED 23 versus the distance between the second and third electrodes 26 and 28. This embodiment of the invention, in which the work functions of two electrodes (26 and 28) bounding the slit are 4.1 V, and the distance d between the two electrodes (26 and 28) is 10 nm, and the potential difference between the two electrodes (26 and 28) is 18 V, can provide the same tunneling probability as that of a conventional SED having a distance d between the two electrodes (26 and 28) less than 10 nm. The gate voltage Vg of the first (gate) electrode and the distance between the second and third electrodes 26 and 28 may be calculated using the Wentzel-Kramers-Brillouin (WKB) approximation.

Referring to FIG. 6, the GC_SED 23 wherein the distance d is 100 nm and the gate voltage Vg is 4V, can have a tunneling probability comparable to the conventional SED having a distance d between the two electrodes (26 and 28) less than 10 nm. Thus, even though the distance between the second and third electrodes 26 and 28 increases to (100 nm) (about ten times greater than the distance d in the conventional SED), the GC_SED 23 can have the same tunneling probability as the conventional SED (e.g., while applying a predetermined gate voltage Vg e.g., 4 V).

Further, as shown in FIG. 6, even if the distance d increases to about 1 μm (1,000 nm), the GC_SED 23 can offer substantially the same tunneling probability as the conventional (e.g., less than 10 nm) SED (by slightly increasing the magnitude of the gate voltage Vg).

Thus, taking into consideration semiconductor devices that are already in mass production, the applicability of LCD manufacturing processes, and the applicable gate voltage range, the distance between the second and third electrodes 26 and 28 in the GC_SED 23 may conveniently range between 10 nm to 1,000 nm (1 μm).

Because the potential barrier for tunneling electrons can be adjusted by changing the magnitude of the gate (bias) voltage Vg, the GC_SED 23 of the present invention may have a distance d (slit width, between the two electrodes bounding an electron-emitting area) greater than the few nanometers of the conventional SED. Thus, the GC_SED 23 and the display employing the GC_SED 23 are easy to manufacture and have reduced manufacturing costs while allowing high volume production. The present invention allows adjustment of electron emission characteristics of an electron emitter device in a pixel by a gate, thus facilitating efficient addressing for each pixel (e.g., active matrix driving of the pixel array).

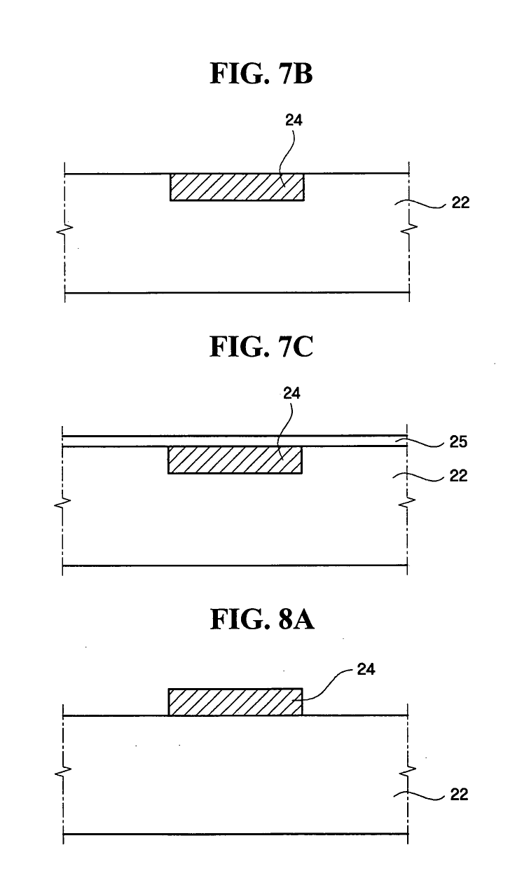

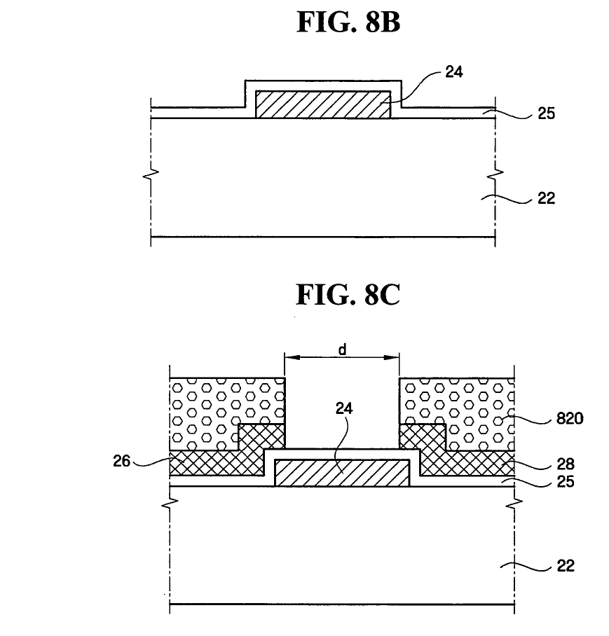

Some embodiments of a manufacturing method for the GC_SED array panel according to one embodiment of the present invention will now be described with reference to FIGS. 7A-8C.

FIGS. 7A-7C are cross-sectional views illustrating a first fabrication method for the GC_SED array panel (20 of FIG. 2A) according to an embodiment of the invention. When a difficult-to-etch metal such as Cu is used as the conductive layer for forming a first electrode 24 having a top surface that is at substantially the same level as the top surface of the substrate 22, it is proper to form the first electrode 24 using the methods shown in FIGS. 7A and 7B. Referring to FIG. 7A, after a first mask 710 is formed on a substrate 22, the first mask 710 is used as an etch mask for etching the substrate 22, thus forming a trench T in which a gate electrode will be formed. The substrate 22 may be a glass substrate made of quartz glass or soda-lime glass, a ceramic substrate made of alumina, or a semiconductor substrate. The substrate 22 can be any kind of substrate to which an established or verified semiconductor device manufacturing process or LCD manufacturing process can be applied. The use of the semiconductor device or LCD manufacturing process can result in the easy manufacturing of GC_SEDs 23.

Referring to FIG. 7B, after removing the first mask 710 used in forming the trench T, a conductive layer (not shown) is buried within the trench T (e.g., deposited below the top surface of the substrate) in the substrate and subjected to planarization, thus completing a first electrode 24 having a top surface that is at substantially the same level as the top surface of the substrate 22. The planarization may be performed using chemical mechanical polishing (CMP) or etch-back. The first electrode 24 may be connected to the first conductive line (124 of FIG. 2A) (e.g., provided later in a metallization step). The first electrode 24 may be formed of copper (Cu), aluminum (Al), titanium (Ti), tungsten (W), or polysilicon doped with impurities (e.g., “gate poly”). The polysilicon (“gate poly”) may be doped with impurities using an in-situ or ex-situ technique.

Referring to FIG. 7C, an insulating layer 25 is formed over the substrate 22 (and over a first electrode 24 e.g., having a top surface that is at substantially the same level as the top surface of the substrate 22) to a thickness of 10 nm to 1 μm. The insulating layer may be or may include an oxide layer (e.g., a metal oxide layer), nitride layer, or high-k dielectric layer.

A second conductive layer (for forming second and third electrodes 26 and 28) and a second mask (not shown) are sequentially formed on the insulating layer 25 and the second mask is used as an etch mask to etch the second conductive layer, thus forming second and third electrodes 26 and 28.

The second and third electrodes 26 and 28 may, similarly, be formed of Cu, Al, Ti, W, or “gate poly” (polysilicon doped with impurities using an in-situ or ex-situ procedure). The distance d (i.e., the width of the slit) between the second and third electrodes 26 and 28 may be 1 nm to 1 μm (e.g., 10 nm to 1,000 nm).

For a subsequent process, the second mask is removed and second and third conductive lines (126 and 128 of FIG. 2A) are formed to allow input/output of an electric signal. The third conductive line 128 may be formed prior to or after forming the second conductive line 126. Then, a passivation layer is formed over the substrate 22, thus completing the GC_SED array panel 20. Detailed descriptions of these subsequent conventional steps will not be given to avoid ambiguous interpretation of the present invention.

When an easy-to-etch conductive layer is formed, it is desirable to form the first electrode 24 by the method illustrated in FIG. 8A.

FIGS. 8A-8C are cross-sectional views illustrating a second fabricating process for the GC_SED panel 20.

Referring to FIG. 8A, a first conductive layer (not shown) (to comprise electrode 24) and a first mask (e.g., 710 in FIG. 7A) are sequentially formed on a substrate 22 and the mask (e.g., 710 in FIG. 7A) is used as an etch mask to etch the first conductive layer, thus forming a first electrode 24. The first electrode 24 may be connected to the first conductive line 124 (e.g., formed later in a metallization step). The first conductive layer (comprising the first electrode 24) may be formed of the same material as described in the first embodiment.

Referring to FIG. 8B, an insulating layer 25 is formed to a thickness of 10 nm to 1 μm over the substrate 22 on which the first electrode 24 has been formed (and on the first electrode 24). The insulating layer 25 may be or include an oxide layer (e.g., a metal oxide layer), nitride layer, or high-k dielectric layer. The second and third electrodes 26 and 28 may also be formed of Cu, Al, Ti, W, or “gate poly” (polysilicon doped with impurities) using an in-situ or ex-situ procedure. The distance d (width of the slit) between the second and third electrodes 26 and 28 may be 1 nm to 1 μm (e.g., 10 nm to 1 μm).

Referring to FIG. 8C, a second conductive layer (not shown) and a second mask 820 are sequentially formed on the insulating layer 25 and the second mask 820 is used as an etch mask to etch the second conductive layer (to comprise electrodes 26 and 28), thus forming second and third electrodes 26 and 28. The second and third electrodes 26 and 28 may also be formed of Cu, Al, Ti, W, or polysilicon doped with impurities using an in-situ or ex-situ procedure. The distance d (the width of the slit) between the second and third electrodes 26 and 28 may be 1 nm to 1 μm (e.g., 10 nm to 1 μm).

For a subsequent process, the mask 820 is removed and second and third conductive lines (126 and 128 of FIG. 2A) are formed (e.g., in a conventional metallization step) to allow input/output of an electric signal. The third conductive line 128 may be formed prior to or after forming the second conductive line 126. Then, a passivation layer is formed on the substrate 22, thus completing the GC_SED array panel 20. Detailed descriptions of these conventional subsequent steps will not be given to avoid ambiguous interpretation of the present invention.

Meanwhile, because the manufacturing of the first panel 10, formation of the spacer 30, and assembling of the first and second panels 10 and 20 using the sealing element 40 (see FIG. 2) while maintaining a vacuum atmosphere therebetween consist of conventional process steps that are widely known to those skilled in the art, their description will be omitted to avoid ambiguous interpretations of the present invention.

As shown in FIGS. 7A-8C, the GS_SED array panel 20 according to the present invention is easy to manufacture using a semiconductor device manufacturing process verified for high volume production because it may have a large distance d (slit width) greater than 10 nm (and less than 1 μm) between the second electrode 26 and the third electrode 28. Thus, a display employing the GS_SED 23 has reduced manufacturing costs while allowing high volume production.

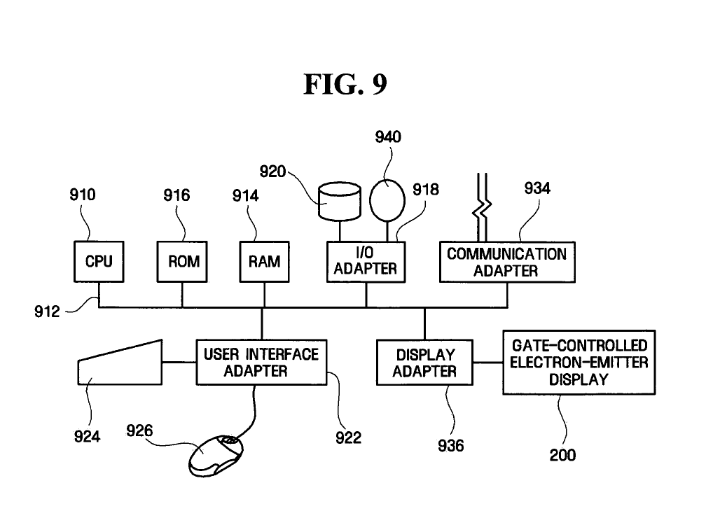

FIG. 9 is a block diagram of an image processing system using a display 200 according to an embodiment of the present invention.

Referring to FIG. 9, the display 200 is connected to a CPU 910 and to an image processing system including a plurality of different units (e.g., a RAM 914, a ROM 916) interconnected via a system bus 912. Thus, the image processing system includes an input/output (I/O) adapter 918 connecting peripheral devices (such as a disc unit 920 and a tape driver 940) to the system bus 912, a user interface adapter 922 connecting peripheral devices (such as a key board 924, a mouse 926, a speaker (not shown), a microphone (not shown), and/or touch screen device (not shown)) to the system bus 912, a communication adapter 934 connecting the image processing system to a data network, and a display adapter 936 connecting the system bus 912 to the display 200.

While the present invention has been particularly shown and described with reference to exemplary embodiments thereof, it will be understood by those of ordinary skill in the art that various changes in form and details may be made therein without departing from the spirit and scope of the present invention as defined by the following claims. Thus, it will be appreciated that the embodiments described above are given by way of illustration and not limitation.

What is claimed is:

1. A display panel comprising:
a first electrode; and
a second electrode and a third electrode that are insulated from the first electrode and are spaced apart from each other and define an electron-emitting area overlapping the first electrode.

2. The display panel of claim 1, wherein a distance between the second and third electrodes is less than 1 μm.

3. The display panel of claim 2, wherein the distance between the second and third electrodes is greater than 10 nm.

4. The display panel of claim 1, wherein the second and third electrodes are insulated from the first electrode by an insulator having a thickness of 10 nm to 1 μm.

5. The display panel of claim 1, wherein a first conductive line connected to the first electrode is arranged perpendicular to a second conductive line connected to the second electrode.

6. The display panel of claim 5, wherein a switchable voltage bias is applied between the first and second conductive lines.

7. The display panel of claim 5, wherein a third conductive line connected to the third electrode is arranged perpendicular to the second conductive line connected to the second electrode.

8. The display panel of claim 7, wherein the third conductive line is commonly connected across the entire substrate.

9. The display panel of claim 1, wherein the first through third electrodes are formed of copper (Cu), aluminum (Al), titanium (Ti), tungsten (W), or polysilicon doped with impurities.

10. A display comprising:
a phosphor array panel; and
a second panel, including an array of gate-controlled electron-emitter devices, that faces the phosphor array panel;
wherein each gate-controlled electron-emitter device includes:
a first electrode;
a pair of second and third electrodes that are insulated from the first electrode and are spaced apart from each other to define an electron-emitting area overlapping the first electrode.

11. The display of claim 10, wherein a distance between the second and third electrodes is less than 1 μm.

12. The display of claim 11, wherein the distance between the second and third electrodes is greater than 10 nm.

13. The display of claim 10, wherein the second and third electrodes are insulated from the first electrode by an insulator having a thickness of 10 nm to 1 μm.

14. The display of claim 10, wherein a first conductive line connected to the first electrode is arranged perpendicular to a second conductive line connected to the second electrode.

15. The display of claim 14, wherein an reversible voltage bias is applied between the first and second conductive lines.

16. The display of claim 14, wherein a third conductive line connected to the third electrode is arranged perpendicular to the second conductive line connected to the second electrode.

17. The display of claim 16, wherein the third conductive line is commonly connected across the entire substrate.

18. The display of claim 10, wherein the first through third electrodes are formed of copper (Cu), aluminum (Al), titanium (Ti), tungsten (W), or doped polysilicon.

19. The display of claim 10, wherein the phosphor array panel and the gate-controlled electron-emitter device array panel are vacuum-sealed.

20. The display of claim 10, wherein a metal back is formed on the phosphor array panel.

21. The display of claim 10, wherein the first electrode is farther away from the phosphor array panel than the second and third electrodes.

22. A method of manufacturing a display panel, comprising:
forming a first electrode on a substrate;
forming an insulating layer on the first electrode; and
forming on the insulating layer a second electrode and a third electrode that are spaced apart from each other to define an electron-emitting area therebetween, wherein the electron-emitting area overlaps the first electrode.

23. The method of claim 22, wherein the distance between the second and third electrodes is less than 1 μm.

24. The method of claim 22, wherein the distance between the second and third electrodes is greater than 10 nm.

25. The method of claim 22, wherein the insulating layer is formed to a thickness of from 10 nm to 1 μm.

26. The method of claim 22, further comprising, after the forming of the second and third electrodes, forming a second conductive line that is connected to the second electrode and is perpendicular to a first conductive line connected to the first electrode.

27. The method of claim 26, further comprising forming a third conductive line that is connected to the third electrode and is perpendicular to the second conductive line.

28. The method of claim 27, wherein the third conductive line is commonly connected across the entire substrate.

29. The method of claim 22, wherein at least one of the first through third electrodes is formed of a selection from copper (Cu), aluminum (Al), titanium (Ti), tungsten (W), or doped polysilicon.
